(19) United States
(12) Patent Application Publication
(10) Pub. No.: US 2023/0182148 A1
(43) Pub. Date: Jun. 15, 2023

(54) MAGNETIC LINK BELT SYSTEM FOR CLARIFYING WATER

(71) Applicant: Janus Automation Group LLC, Boca Raton, FL (US)

(72) Inventor: Peter Janus, Boca Raton, FL (US)

(21) Appl. No.: 17/795,132

(22) PCT Filed: Jul. 6, 2022
(86) PCT No.: PCT/US2022/036245

§ 371 Date: Jul. 25, 2022

Related U.S. Application Data
(60) Provisional application No. 63/218,515, filed on Jul. 6, 2021.

(51) Int. Cl. B03C 1/20; C02F 1/56; C02F 1/52; C02F 1/48; B03C 1/01; B03C 1/30; B03C 1/12

(52) U.S. Cl. CPC B03C 1/20; C02F 1/56; C02F 1/5281; C02F 1/488; B03C 1/01; B03C 1/30; B03C 1/12; B03C 2201/18

(57) ABSTRACT

A belt system for a water treatment system comprising a flocculation tank. The flocculation tank is configured for receiving wastewater having one or more of unwanted waste solids, unwanted particulates, suspended solids via the ingress and for mixing the wastewater with a flocculating agent and magnetite within the flocculation tank. The belt system comprises a looped belt comprising a plurality of rare earth magnets. The first looped belt is mounted within an extraction portion of the flocculation tank. A first portion of the first looped belt is above a water level inside the flocculation tank. A second portion of the first looped belt is submerged in the flocculation tank. A first scraper is positioned proximate to the first looped belt that is above the water level. A container is below the first scraper and the first looped belt and above the water level. An auger is within the container.

### CROSS-REFERENCE TO RELATED APPLICATIONS

This application claims the benefit of the filing date of U.S. Provisional Application Serial No. 63/218,515 titled “MAGNETIC LINK BELT SYSTEM FOR CLARIFYING WATER” and filed Jul. 6, 2021, and the subject matter of which is incorporated herein by reference.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of water treatment, and more specifically to the field of flocculation tanks for clarifying water.

### BACKGROUND

Typically, a flocculation tank is a large vessel with sidewalls and an interior volume that is suitable to receive wastewater for producing a physicochemical reaction therein. The flocculation tank receives the wastewater and chemicals in sequence to enable tiny solid particulate matter to collect together in a larger mass. It is known in the art that natural polymers are effective for flocculating waste particles. It is also known that magnetite is a magnetized element that binds with waste particles and polymers; thereby creating flocs inside the flocculation tank. Specifically, the magnetite destabilizes suspended particulates in raw wastewater by neutralizing the electrochemical charges typically found on colloidal particles and contaminants.

Various methods may be used to help carry the coagulated flocs from the wastewater to a discharge point. However, such methods are typically slow and have limited capacity for cleaning wastewater. Additionally, the prior art flocculation tanks do not have an efficient structure for breaking the bond between the magnetite, and the polymers and unwanted particulates, before discharging. For example, the prior art uses settling or filters to remove the flocs. Settling, which involves allowing the floc to settle to the bottom for removal, and filters, which accumulate floc, are time-intensive when removing the flocs from the tank. Filters also require maintenance very often because a large accumulation of floc in the filters decrease effectiveness and, therefore, requires periodic cleaning and/or replacing.

As a result, there exists a need for improvements over the prior art and more particularly for a more efficient way clarifying wastewater.

### SUMMARY

A system and method for a belt system for a water treatment system is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a belt system for a water treatment system comprising a flocculation tank is disclosed. The flocculation tank is configured for receiving wastewater having one or more of unwanted waste solids, unwanted particulates, suspended solids via the ingress and for mixing the wastewater with a flocculating agent and magnetite within the flocculation tank. The belt system comprises a looped belt comprising a plurality of rare earth magnets. The first looped belt is mounted within an extraction portion of the flocculation tank. A first portion of the first looped belt is above a water level inside the flocculation tank. A second portion of the first looped belt is submerged in the flocculation tank. A first scraper is positioned proximate to the first looped belt that is above the water level. A container is below the first scraper and the first looped belt and above the water level. An auger is within the container. A pod for a belt of the belt system for use in the water treatment system is also disclosed. The pod comprises a body comprising a middle portion, a first end portion, a second end portion and at least one magnet. The pod comprises a first receiving section at the first end portion. The pod further comprises a second receiving section at the second end portion. The pod comprises a top side of the pod and a bottom side of the pod. The at least one magnet is disposed in the body such that each of the top side and the bottom side have magnetic properties. A pocket is within the body, wherein the pocket comprises a first magnet receiving section and a second magnet receiving section. A first magnet is disposed within the first magnet receiving section proximate to the top side. A second magnet is disposed within the second magnet receiving section proximate to the bottom side; and a spacer is between the first magnet and the second magnet.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1a is a perspective side view of a diagram of main components of an exemplary flocculation-based system for clarifying water, according to an example embodiment;

FIG. 1b is a side, cutaway view of a diagram of main components of a belt system for a water treatment system, according to an example embodiment;

FIG. 1c is a side, perspective partial cutaway view of main components of a belt system for a water treatment system, according to an example embodiment;

FIG. 2 illustrates a perspective view of an exemplary first looped or continuous belt, according to an example embodiment;

FIG. 3 illustrates a perspective view of a housing or pod containing rare earth magnets, according to an example embodiment;

FIG. 4 illustrates a side view of the housing containing rare earth magnets, according to an example embodiment;

FIG. 5 illustrates a side view of a portion of an exemplary belt path, according to an example embodiment;

FIG. 6 illustrates a perspective view of multiple housings or pods joined in a belt configuration with connector rods, according to an example embodiment;

FIG. 7 illustrates a perspective view of an exemplary discharge duct, according to an example embodiment;

FIG. 8 illustrates a perspective view of an exemplary magnetic drum carrying a second looped or continuous belt, according to an example embodiment;

FIG. 9 illustrates a perspective view of a portion of a belt for a flocculation tank system, according to an example embodiment;

FIG. 10 illustrates a perspective view of a pod or housing for a flocculation tank system, according to an example embodiment;

FIG. 11 illustrates a side view of the housing or pod, according to an example embodiment;

FIG. 12A illustrates a top view of the pod, according to an example embodiment;

FIG. 12B illustrates a cross-sectional side view of the pod from FIG. 12A, according to an example embodiment;

FIG. 13 illustrates a perspective view of the pod, according to an example embodiment;

FIG. 14 illustrates a side view of the pod from FIG. 13, according to an example embodiment;

FIG. 15A illustrates a top view of the pod, according to an example embodiment;

FIG. 15B illustrates a cross-sectional side view of the pod from FIG. 15, according to an example embodiment;

FIG. 16 illustrates a perspective view of the pod, according to an example embodiment;

FIG. 17 illustrates a side view of the pod from FIG. 16, according to an example embodiment;

FIG. 18A illustrates a top view of the pod, according to an example embodiment;

FIG. 18B illustrates a cross-sectional side view of the pod from FIG. 18A, according to an example embodiment;

FIG. 19 illustrates a side view of the connected pods traversing around the gears, according to an example embodiment;

FIG. 20 illustrates a side view of the connected pods traversing around the gears, according to an example embodiment;

FIG. 21 illustrates a cross-sectional side view of the portion the belt for the flocculation tank system, according to an example embodiment;

FIG. 22 illustrates a view of the belt system for a water treatment system, according to an example embodiment; and

FIGS. 23A and 23B illustrate a pod having receiving sections, according to another example embodiment.

Like reference numerals refer to like parts throughout the various views of the drawings.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing an efficient means for clarifying wastewater. The claimed subject matter reduces or eliminates the requirement that a single looped belt or conveyor is used to carry the flocs for separation and discharge. Also, the use of multiple vertical belts disposed at a vertical, and orthogonal to the first looped belt helps increase surface area for carrying the magnetic agents and unwanted particulates. The claimed subject matter also improves over the prior art by providing a more efficient, automated and precise way of increasing computer download speeds.

As used herein, “flocculating agent” means a chemical additive that causes suspended solids in water to form aggregates (called “flocs”). Flocculating agents may be used in water treatment, municipal and industrial waste treatment, mineral processing, and papermaking, to name a few industries. Non-limiting examples of flocculating agents include inorganic salts, and water-soluble organic polymers. Generally, flocculating agents avail the bonds formed within the flocs and promotes processing downstream as described in greater detail below. Flocs may comprise magnetic agents such as magnetite, flocculating agents, sludge and other unwanted particulate matter present in the water.

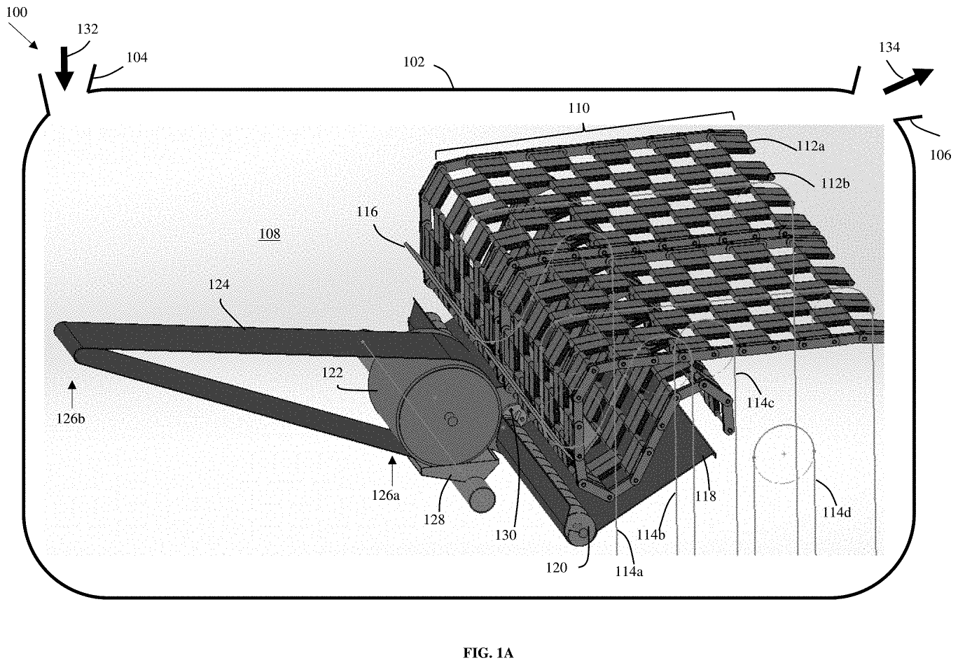

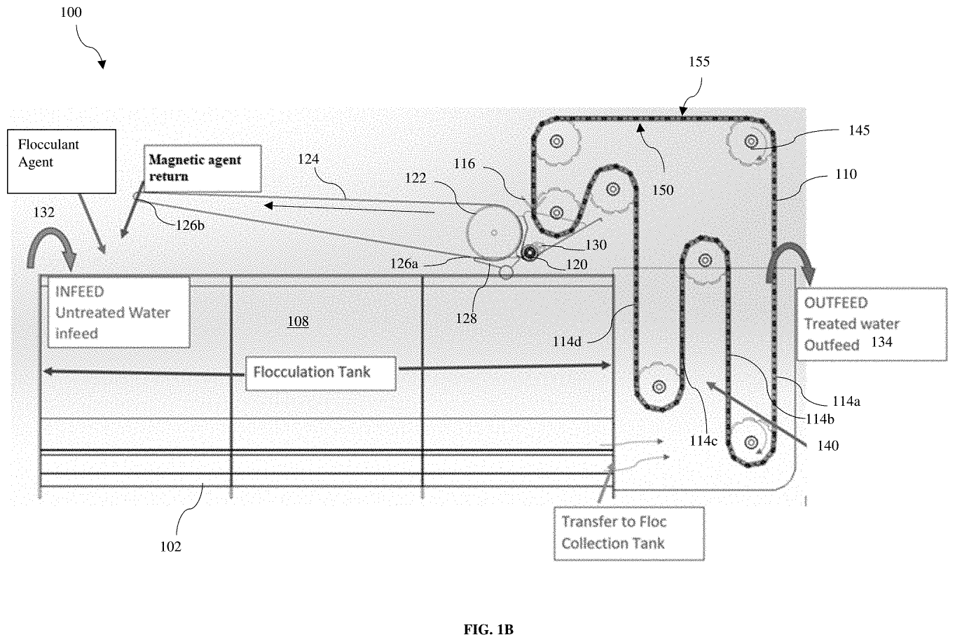

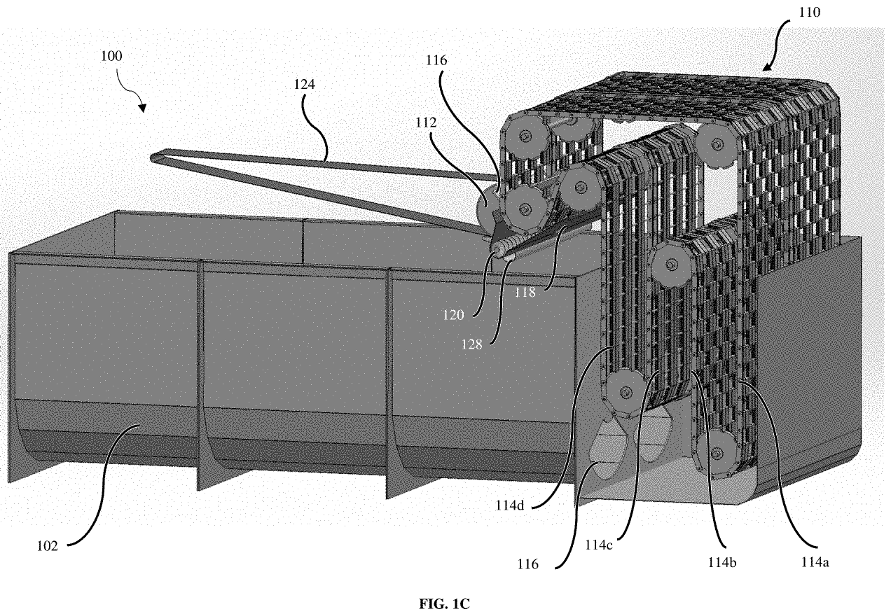

Referring now to the Figures, FIGS. 1a-1c show a belt system for a water treatment system. The water treatment system 100 is a flocculation-based system that helps purify and/or clarify wastewater inside a flocculation tank 102 through chemical means, by introducing a magnetic agent(s) and at least one flocculation agent into the flocculation tank 102. The consequential physical and chemical reactions work to separate the unwanted particulates from the wastewater 108. In this process, the flocculating agent, magnetic agent(s) and unwanted particulates coagulate together to form flocs. To capture and guide the floc, the system 100 operates a magnetized first looped belt 110 that is configured to: 1) draw the flocs from the wastewater inside the flocculation tank 102; and 2) carry the flocs to additional components for separating the magnetic agent(s) (e.g., magnetite) from the polymers and unwanted particulates in the wastewater 108 (described below).

In some embodiments, at least three vertically arranged belt segments 114a-114d span a substantial portion of a height of the flocculation tank. The belt segments 114a-114d operate in conjunction with the first looped belt 110. The belt segments 114a-114d orient vertically defining a vertical belt path, and substantially below the water level inside the flocculation tank 102. The belt segments 114a-114d enhance the water clarifying by feeding additional flocs from below the water level onto the first looped belt 110. Advantageously, the use of belt segments 114a-114d increases the surface area of the first looped belt 110 since a greater number of flocs is drawn from the wastewater and loaded onto the first looped belt 110.

In some embodiments, a first scraper 116 engages the first looped belt 110 and/or the belt segments 114a-114d to remove the magnetic agent(s), polymer, and unwanted particulate that adhere to the looped belts 110, 114a-114d. A second looped belt 124 receives the scraped magnetic agent(s), polymer, and unwanted particulate. A second scraper scrapes off the magnetic agent(s), polymer, and unwanted particulate from the second looped belt 124. An auger 120 drives the magnetic agent(s) and unwanted particulates and breaks the bond between the magnetic agent(s) and unwanted particulates for discharge into a discharge duct 128. The auger is an elongated device with helical threads and rotates such that the helical threads separate the magnetic agents and unwanted particulates. A magnetic drum 122 separates and enables recirculation of the magnetic agent(s) from the polymer for reuse with new wastewater that is introduced into the flocculation tank 102.

As FIGS. 1a-1c references, the system 100 provides a flocculation tank 102. The flocculation tank 102 may include a vessel having sidewalls and an interior volume suitable to receive wastewater 108 for producing a chemical reaction therein. The flocculation tank 102 receives the wastewater 108, magnetic agent(s), and flocculating agents in sequence, which coagulates the tiny solid particulate from the wastewater in a larger mass, i.e., flocs. In some embodiments, the unwanted particulates and the suspended solids may include, without limitation, biosolids, t-norm, and diluted chemicals that can be adsorbed by the flocculating agents, such as flocculating polymers and/or other additives/agents.

In one possible embodiment, the flocculation tank 102 defines an ingress 104 to enable entrance of a wastewater that contains unwanted solids and unwanted particulates. The ingress 104 can include a simple opening, or a protruding threaded rim that facilitates coupling with a hose or pipe that introduced the wastewater from an external source. Suitable materials for the flocculation tank 102 may include, without limitation, stainless steel, iron, titanium, metal alloys, and ceramic. The flocculation tank 102 may have a cubicle shape, a rectangular shape, a spherical shape, or any other shape, such as irregular shapes which are within the spirit and scope of the invention.

As discussed above, the flocculation tank 102 is configured for multiple functions. A first function of the flocculation tank 102 is to receive, through the ingress 104, wastewater that has unwanted particulates. The wastewater can include waste from a water processing plant, contaminated freshwater, or ocean water that requires clarifying/purification. Another function of the flocculation tank 102 is to provide a vessel for mixing the wastewater with a flocculating agent and magnetic agent(s) within the flocculation tank 102. This creates flocs in the wastewater that can be more readily removed. In one non-limiting embodiment the flocculating tank 102 is about 75% full of wastewater, and 25% empty. This creates a predetermined water level inside the flocculating tank 102.

As noted above, magnetic agents (e.g., magnetite) and flocculating agents (e.g., natural polymers) are also introduced into the flocculating tank 102. It is known in the art that magnetite is a magnetized element that binds with waste particles and flocculating polymers; thereby creating flocs inside the flocculation tank 102. Specifically, the magnetite destabilizes suspended unwanted particulates in raw wastewater 108 by neutralizing the electrochemical charges typically found on colloidal particles and contaminants. It is also known in the art that some natural polymers are effective for flocculating particulates from a liquid. Typically, the unwanted particulates inside the wastewater can include, at least: biosolids, t norm, and diluted chemicals that can be absorbed by the polymer or other additives/agents.

The flocculation tank 102 taught here, contains various looped belts 110, 114a-114d, 124; an auger 120; a magnetic drum 122; a container 118; and a discharge duct 128 that create synergistic flocculation process to produce the flock, and subsequently separate the flocs for discharge of the unwanted particulates.

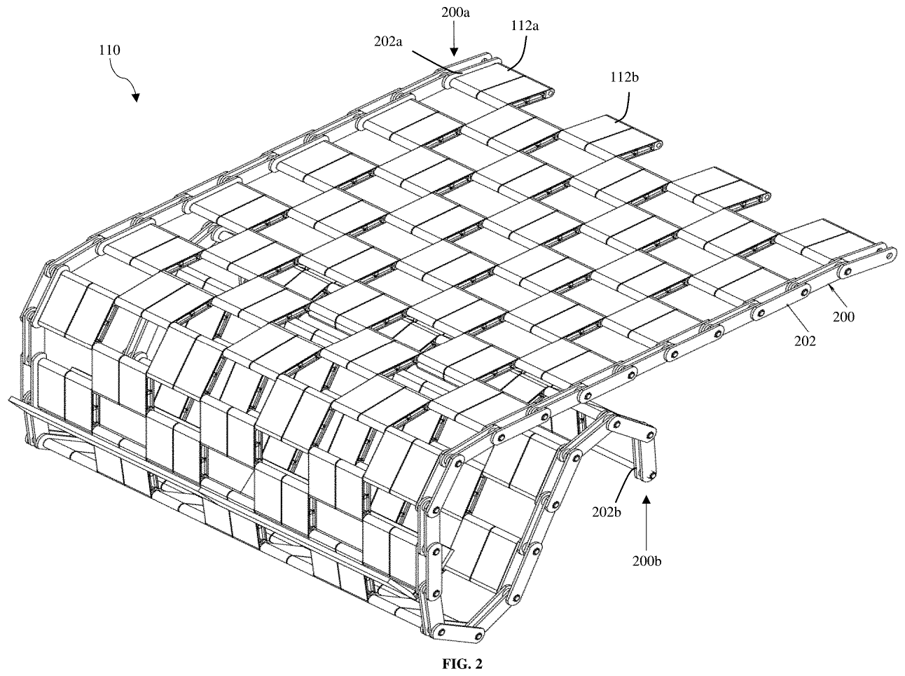

As illustrated in FIG. 2, the first looped belt 110 is vertically arranged, at least below the water level within the flocculation tank, and configured such that flocs comprising unwanted particles, magnetic agent(s), and flocculating agents adhere to the first looped belt as the first looped belt moves through water below the water level. In another possible embodiment, the first looped belt 110 extends horizontally across a substantial length of the longitudinal of the flocculation tank 102 (See FIGS. 1a-1c). In yet another embodiment, the first looped belt 110 may extend vertically or at a diagonal across the flocculation tank 102. In this horizontal disposition, the first looped belt 110 rotatably articulates in a conveyor belt-type configuration to magnetically draw the flocs and carry the flocs for separation and discharge at additional components inside the flocculation tank 102.

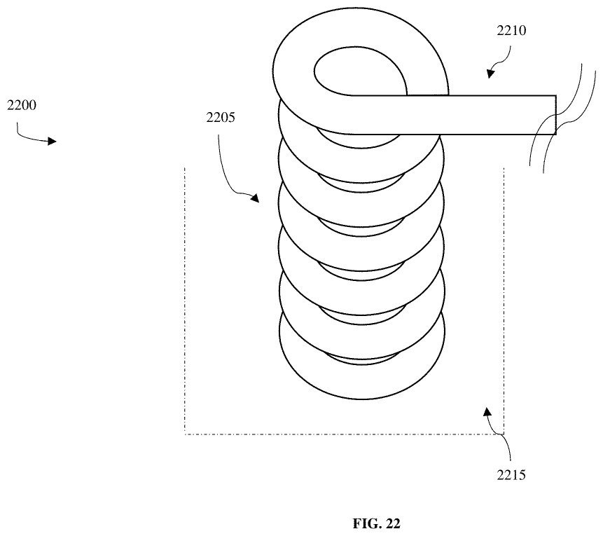

As Illustrated in FIG. 1c, at least one gear of a belt path is above a second gear of the belt path creating column. The belt path is defined a plurality of rotating elements, such as gears 145, on which the looped belt traverses. In other embodiments, the rotating elements may be pullies; however, other types of rotating elements may be used and are within the spirt and scope of the disclosure. Each side of the belt is defined by the portion of the belt that contacts the gears and/or rotatable elements about the belt path. The middle portion of the belt is where the flocs and magnetic agents adhere. The middle portion of the belt includes an inner side 150 and an outer side 155, illustrated in FIG. 1b. The inner side of the belt faces inwards to the loop of the belt while the outer side of the belt faces outwards from the loop of the belt. In one embodiment, the belt is a continuous fabric or material having magnets disposed within the middle portion. The gears are separated at a distance that depends on the radius of each gear. Gears with smaller radiuses may have smaller separation distances than gears with larger radiuses do. The belt includes a first portion and a section portion that are arranged about the substantially vertical belt path such that such that the first looped belt comprises at least two substantially vertically arranged sections. As illustrated in FIG. 1b, the vertically arranged sections may create columns that are submerged in the floc collection tank. The columns created by the belt path and the vertically helical belt path (illustrated in FIG. 22) allows for increased surface area of the belt to move within the water of the floc collection tank. thereby increasing the amount of floc collected from the tank. The collection of more floc decreases the time for clarifying the water within the flocculation tank and increases the efficiency of the water treatment system. The prior art utilizes horizontal paths that does not permit flocs to attach to both sides of belt. A horizontal path not ideal because horizontal paths require a series of rollers and numerus supporting elements, which decrease the surface area on which flocs are collected, to hold up the heavy belt with accumulated flocs.

As illustrated in FIG. 2, the first looped belt 110 is vertically arranged, at least below the water level within the flocculation tank, and configured such that flocs comprising unwanted particles, magnetic agent(s), and flocculating agents adhere to the first looped belt as the first looped belt moves through water below the water level. In another possible embodiment, the first looped belt 110 extends horizontally across a substantial length of the longitudinal of the flocculation tank 102 (See FIGS. 1a-1c). In yet another embodiment, the first looped belt 110 may extend vertically or at a diagonal across the flocculation tank 102. In this horizontal disposition, the first looped belt 110 rotatably articulates in a conveyor belt-type configuration to magnetically draw the flocs and carry the flocs for separation and discharge at additional components inside the flocculation tank 102.

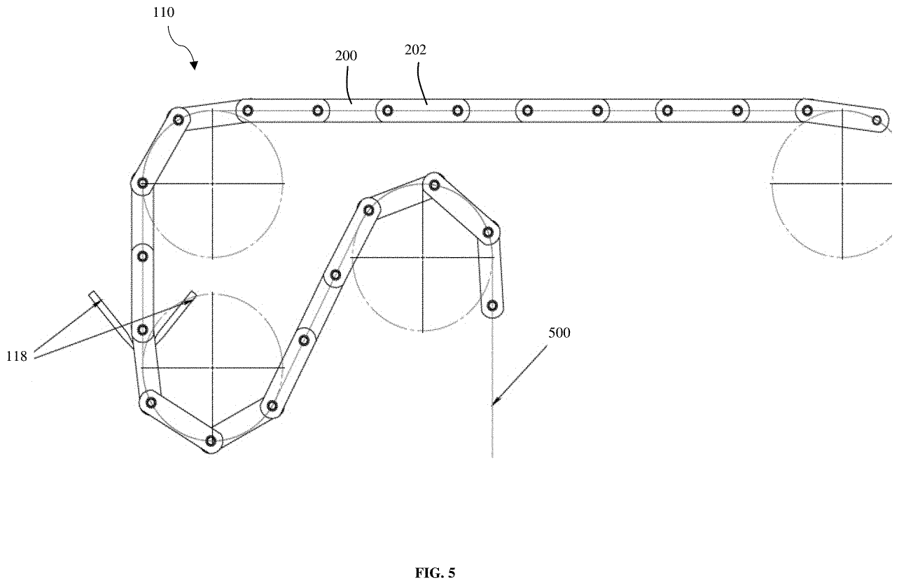

As illustrated, the first looped belt 110 is partially under the water level of the wastewater 108; and partially above the water level of the wastewater. In one possible embodiment, the first looped belt 110 is configured, such that at least a portion of the first looped belt 110 is above the water level. In this manner, a top section of the first looped belt 110 emerges above the water level of the wastewater; and a bottom section of the first looped belt 110 immerses below the wastewater, all while following a rotatable belt path (for example, rotatable belt path 500 in FIG. 5) about the flocculation tank 102. In one embodiment, for example, FIG. 5 illustrates a side view of an exemplary belt path 500. Thus, by rotating at least partially under the water level, the flocs in the wastewater adhere to the first looped belt 110 while rotating through wastewater below the water level. In another embodiment, the first looped belt is mounted on a plurality of rotating elements such that the belt path is continuous about a helix and/or helical shape, as exemplified in FIG. 22. The helix is configured such that the flocs adhere to the first looped belt as the first looped belt moves through water below the water level. The belt moves in a continuous helical path to provide increased surface area for the belt to contact the flocs within the flocculation tank at least below the water level. The helix portion (2205 of FIG. 22) of the belt is positioned within the floc collection tank while the top portion (2210 of FIG. 22) of the belt is positioned above water.

Existing systems have a single horizontal path that does not have a lot of surface area to accumulate flocs. The verticality of the looped belt and the belt path provides more surface area of the belt within the water. More surface area of the belt allows for more floc to be attached to the belt as the belt moves. The chains on the gears of the belt system are vertically arranged so that the flocs can magnetically stick to both sides of the belt without clogging the tracks or becoming stuck on the horizontal support beams.

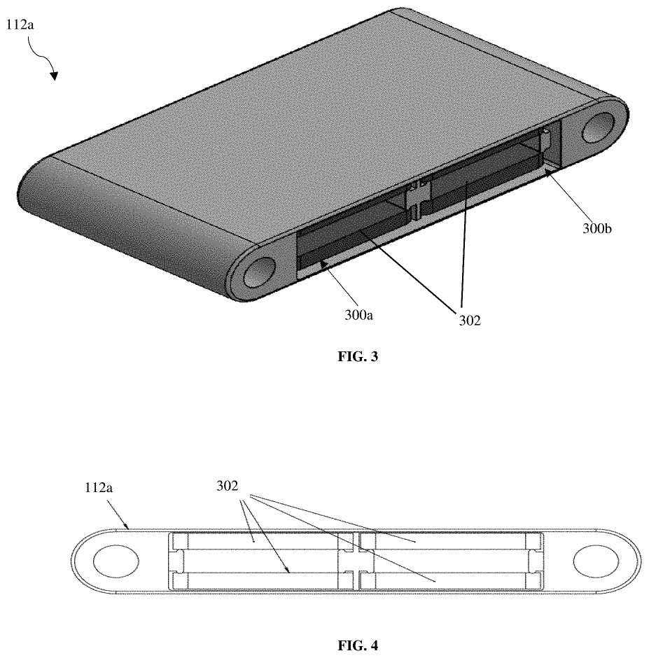

Referring now to FIG. 3, to magnetize the first looped belt 110, the first looped belt 110 is made up of at least one housing 112a, 112b that encases at least one rare earth magnet 302. The first looped belt comprises a plurality of housings connected to each other in a linkage configuration having an inner link 200 and an outer link 202 joined at pivotable hinges. The housings surround each of the plurality of housings to form the first looped belt (See FIG. 4).

As shown in FIG. 5, multiple housings 112a-112b are linked together across the surface of the first looped belt, or actually join to form the first looped belt 110. In one embodiment, a plurality of housings 112a, 112b connect to form the first looped belt 110. This creates a magnetized first looped belt, efficacious for drawing flocs from the wastewater. Looking again at FIG. 2, the first looped belt 110 comprises a first side end 200a defined by a first side element 202a connected to a plurality of adjacent first side segments. Similarly, the first looped belt 110 has a second side end 200b defined by a second side element 202b connected to a plurality of adjacent second side segments.

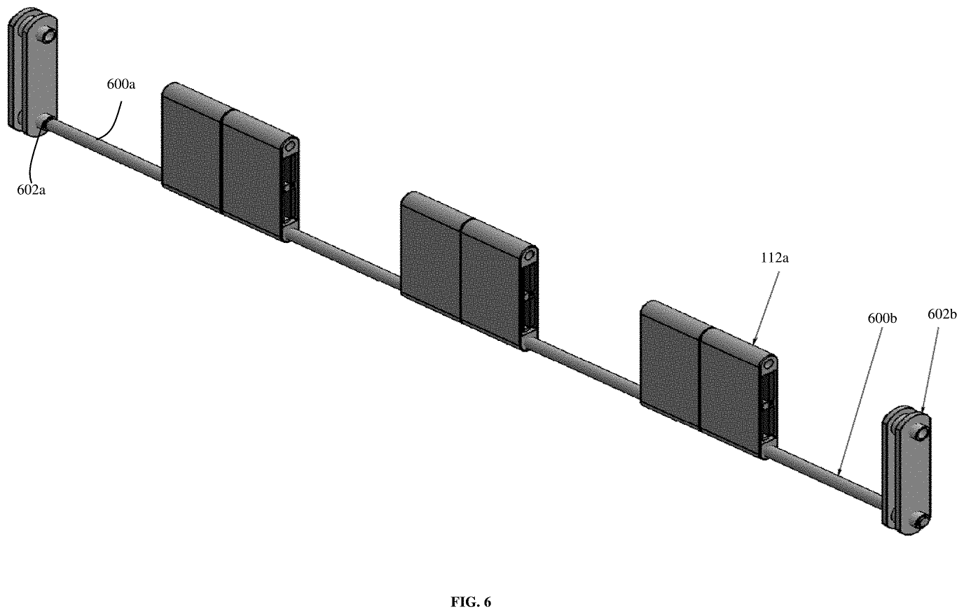

Connector rods 600a-b connect and align the housings together. For example, FIG. 6 illustrates multiple housings 112a-112b joined in a belt configuration with connector rods 600a-b. As illustrated, the housings 112a-112b define a first receiving portion or opening 602a for receiving a first connector rod 600a; and a second receiving portion or opening 602b for receiving a second connector rod 600b. The connector rods 600a-b help align the housings 112a-112b in a parallel relationship to create the belt-shaped configuration of first looped belt 110.

In a unique arrangement of connected housings 112a, 112b, which allows the first looped belt 110, and other looped belts discussed below, to be magnetized. The housings 112a-112b form cavities 300a, 300b at the sides. Each of the plurality of housings encases the at least one rare earth magnet 302 inside the cavities 300a-b. The rare earth magnet 302 enables the first looped belt 110 to be magnetized; and thereby carry the flocs. Each magnet may be fixed within a slot inside the cavity such that the rare earth magnet if fixed and does not move within the cavities 300a-b. However, in other embodiments as explained below, the magnets not be fixed and allowed to move within the cavity.

In some embodiments, the housing 112a, 112b may have, without limitation, a square shape, a rectangular shape, triangular shape, a circular shape, or an irregular shape. The housing 112a, 112b allows the magnetic agent(s) and the coagulated polymer and unwanted particulates to cling to the first looped belt 110 during rotation, both above and below the water level. Thus, as the first looped belt 110 rotates under the water level the attached magnetized flocs bind to the housing 112a, 112b. As discussed below, above the water level is where the flocs are forcibly removed from the first looped belt 110 for separation and discharge.

To amplify the effects of the first looped belt, the system 100 comprises multiple belt segments 114a-114d. The belt segments 114a-114d mount inside the flocculation tank 102 in much the same structural configuration as the first looped belt 110. The belt segments 114a-114d are also magnetized through use of the housings 112a, 112b that are arranged across the surface of the belt segments 114a-114d, or integrally become a part of the belt segments 114a-114d. Consequently, the belt segments 114a-114d are configured such that the flocs adhere thereto as the belt segments 114a-114d rotates below the water level.

In one embodiment, the belt segments 114a-114d are in operational proximity to the first looped belt 110, such that the belt segments 114a-114d feed at least a portion of the flocs to the first looped belt 110. In one embodiment, the belt segments 114a-114d are also oriented vertically, crossing the path of the first looped belt 110 at an orthogonal. Thus, as the first looped belt 110 and the belt segments 114a-114d are proximal to each other, the flocs move from the belt segments 114a-114d to the first looped belt 110.

This transfer of flocs between looped belts 110, 114a-114d may be possible because the housing 112a of the first looped belt 110 has a greater magnetic force than the housing 112b of the belt segments 114a-114d. This helps draw magnetic agent(s) and unwanted particulates to cross from the vertically oriented belt segments 114a-114d to the horizontally oriented first looped belt 110.

Another possible means for the transfer of flocs between looped belts 110, 114a-114d could be a first scraper 116 that is oriented to scrape the magnetically collected flocs from the belt segments directly onto the first looped belt 110 during the rotation therebetween. In this arrangement, the first scraper 116 is disposed at the nexus of the looped belts 110, 114a-114d. However, in other embodiments, there can be other physical forces, gravitational forces, structural configurations, and magnets that enable magnetic agent(s) and unwanted particulates to cross from the vertically oriented belt segments to the horizontally oriented first looped belt.

As just mentioned, the system 100 provides at least one first scraper 116 that positions proximate to the portion of the first looped belt that is above the water level. In one non-limiting embodiment, the at least one first scraper is disposed on a first side of the first looped belt above the water level, and at least a second scraper is disposed on a second side of the first looped belt above the water level.

As FIGS. 1a-1c illustrates, the first scraper 116 is configured to forcibly scrape the flocs comprising the magnetic agent(s), flocculating agents, and unwanted particulates, which adhere to the first looped belt. The unwanted particulate that is removed includes particulate moved by the first looped belt 110, though the water within the flocculation tank. The first scraper 116 can also be used to scrape the flocs from the belt segments 114a-114d, and onto the first looped belt 110. This, in essence, maximizes the surface area of the first looped belt 110 for carrying flocs.

To capture contaminants in the wastewater, the system 100 provides a container 118 that is disposed below the first scraper 116 and the first looped belt 110. The container 118 is disposed above the water level and is configured for engaging the flocs on the first looped belt 110. In some embodiments, the container 118 may be an elongated vessel that has substantially the same width as the first looped belt 110. The container 118 also has holes at the ends to fit and enable rotatable articulation of an auger 120, described below.

To help drive and separate the flocs, the system 100 provides at least one auger 120. The auger 120 rotates longitudinally inside the container 118, following a helical path that creates turbulence inside the container 118. Because of the auger 120, the bond in the flocs between the magnetic agent(s) and the remaining components (e.g., flocculating agents and unwanted particulates) is broken by rotational forces created by a paddle discharge unit mounted at the end of the auger, such that the breakage of the bond is caused by shear forces.

While helically rotating inside the container 118, the auger 120 is configured to drive the flocs to the center of the container 118. Once driven to the center of the container 118, the helical motion of the auger 120 breaks the bond between the magnetic agent(s) and the flocculating agents and unwanted particulates.

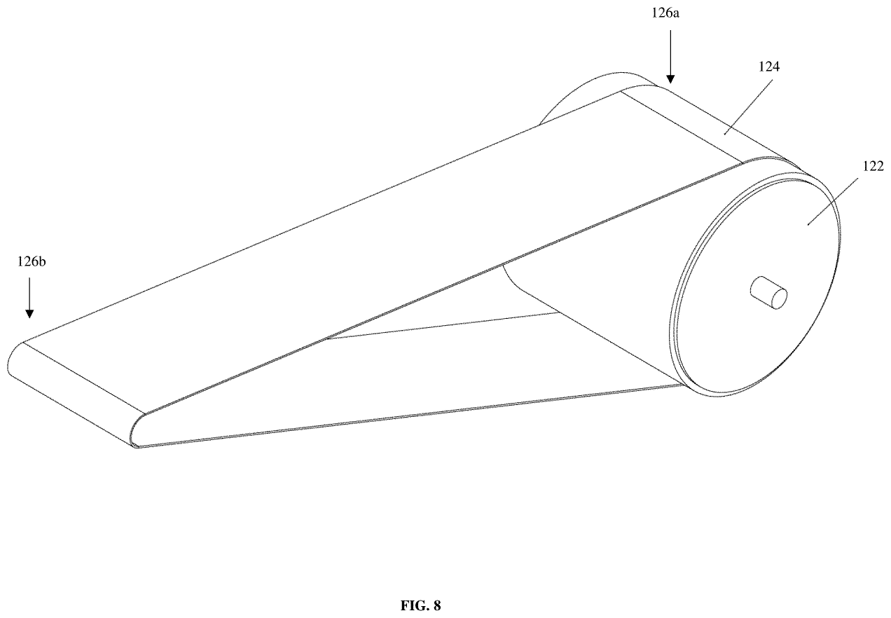

Referring now to FIG. 8, the system 100 also includes a magnetic drum 122 that is proximate and adjacent to the container 118. The magnetic drum 122 primarily serves to draw the magnetic agent(s) from the flocs. The flocs are then scraped off the first magnetic drum.

In relation to the magnetic drum 122, the system 100 also provides a second looped belt 124 that operates in conjunction with the first looped belt 110. The second looped belt 124 has a first end 126a that orients towards the magnetic drum 122, and a second end 126b that orients away from the magnetic drum 122. In this arrangement, the first end 126a of the second looped belt 124 positions, such that the second looped belt 124 covers the outward facing surface of the magnetic drum 122. And the second end 126b of the second looped belt 124 positions near the ingress 104 of the flocculation tank 102, rotating in a direction from the magnetic drum 122 to the ingress 104.

To help in circulating the magnetic agent(s) separated from the flocs, a paddle 130 is used. The paddle 130 attaches proximate to a first position on the auger 120. The paddle 130 is configured to rotate in synchronization with the auger 120. In one embodiment, the paddle 130 moves from within the container 118, and onto the second looped belt 124 surrounding magnetic drum 122. In some embodiments, the paddle 130 may have an elongated handle and a wide base that serves to push the flocculating agents and unwanted particulates from the flocs towards a discharge duct 128.

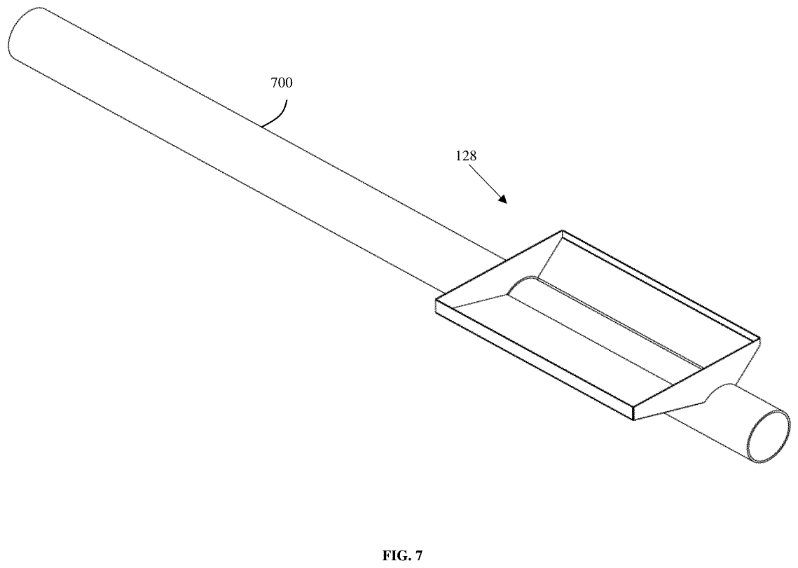

Referring now to FIG. 7, the system 100 provides a discharge duct 128 that is sized and dimensioned to capture the excess unwanted particulate and polymers that disengage from the magnetic drum 122. The discharge duct 128 pivots about an axle 700, such that the discharge duct has pivotable flexibility to capture a maximum number of unwanted particulates and flocculating agent from the flocs. In this pivotal arrangement, the discharge duct forms a channel that enables passage of axle 700.

In this manner, the paddle 130, which is operatively disposed proximate to the magnetic drum 122, drives unwanted particulate off the magnetic drum 122. And as the magnetic drum 122 rotates, the magnetic agent(s) sticks to the magnetic drum 122, and the unwanted particulates are forced to fall into the discharge duct 128. For example, the magnetic agent(s) adheres to the second looped belt 124 on the magnetic drum 122; while the unwanted particulates and flocculating agents run off the magnetic drum 122 and second looped belt 124 to drain into the discharge duct 128.

Continuing with the flow of the magnetic agent(s), the second looped belt 124 moves the magnetic agent(s) that adhere to the magnetic drum 122. In one embodiment, the second looped belt 124 rotates from the first end 126a (proximate to the drum 122) to the second end 126b (proximate to the ingress). Additionally, at least one second scraper (not shown), is located proximate to the second looped belt 124, proximate to the ingress of the flocculation tank.

The second scraper is configured to help remove the magnetic agent(s) from the second looped belt 124 as the second looped belt 124 rotates towards the ingress. This causes the magnetic agent(s) to fall back into the flocculation tank 102 to recombine with the flocculating agents and wastewater 132 entering the flocculation tank. Finally, a first egress moves the cleaned wastewater 134 out of the flocculation tank through the open egress 106.

In operation, new wastewater 132 is introduced into the flocculation tank 102 through the ingress 104. The ingress 104 may be a threaded pipe or hose that couples to a threaded or ribbed configuration of the ingress. After a predetermined amount of wastewater is introduced into the tank 102, magnetic agent(s) and flocculating agents are also added through the ingress. At this point, flocculating occurs in the wastewater as the magnetic agent(s), flocculating agents, and unwanted particulates coagulate together.

The first looped belt 110 is then rotated, partially under the water level of the wastewater, in order to magnetically draw the flocs onto the surface of the first looped belt 110. The magnetic housings 112a, 112b enables the surface of first looped belt 110 to be magnetized in such a manner The belt segments 114a-114d are also rotated to magnetically draw excess flocs from under the water level and feed the first looped belt 110 the captured flocs. This, in essence, increases the surface area of the first looped belt as a greater quantity of flocs forms onto the surface thereof.

Continuing with the operation, the first scraper 116 removes the flocs from the first looped belt, for capture in the container 118. Inside the container 118, the auger 120 rotates in a helical path to drive the flock towards the center of the container 118, and to help break the bond between the magnetic agent(s) and the unwanted particulates. The magnetic drum 122 then draws the magnetic agent(s) away from the polymer and unwanted particulates.

Next, the second looped belt 124 is rotated to draw and carry the magnetic agent(s) for recirculation. And finally, a paddle helps drive and circulate the unwanted particulates towards a first egress 106. This results in production of clarified wastewater being forced out of the egress 106 in the flocculation tank 102. Finally, new wastewater 132 enters the flocculation tank 102 through the ingress 104.

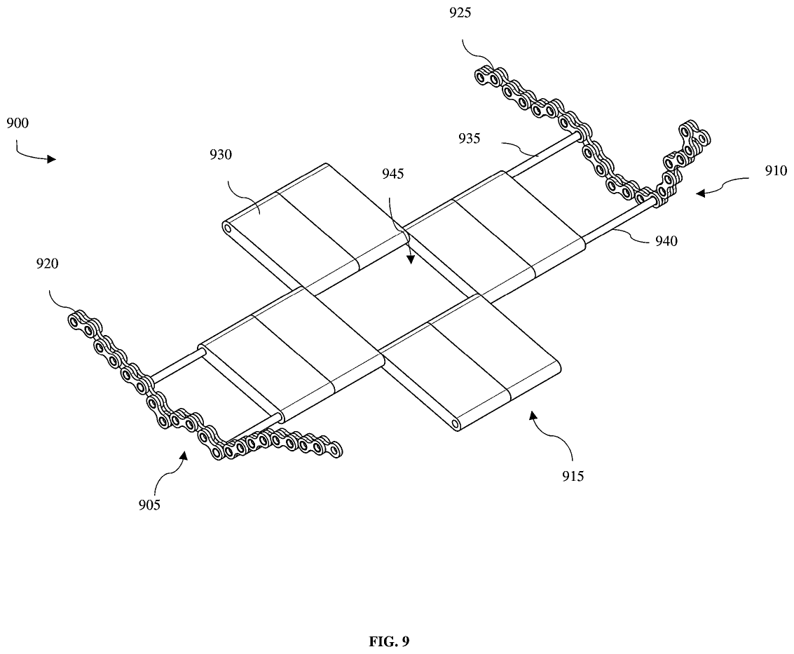

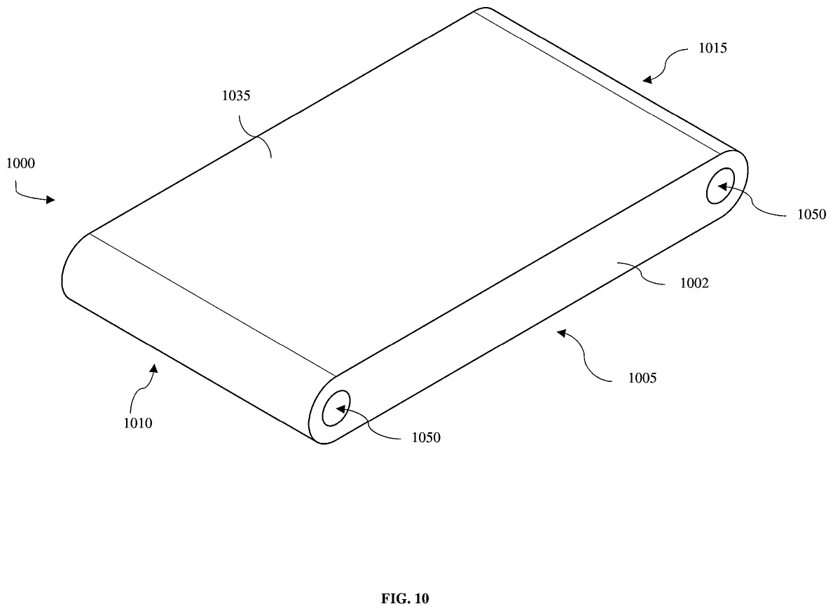

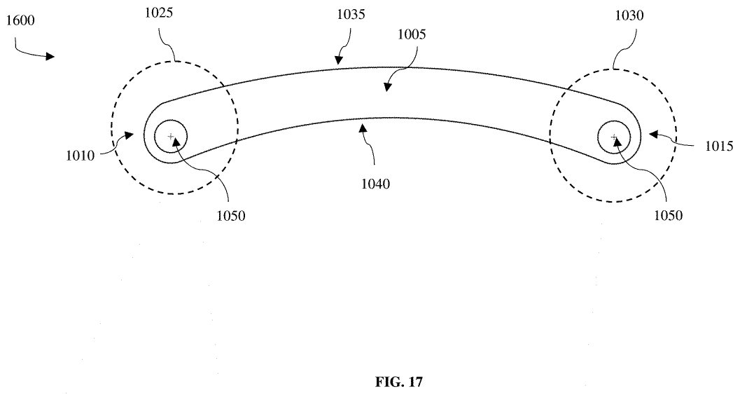

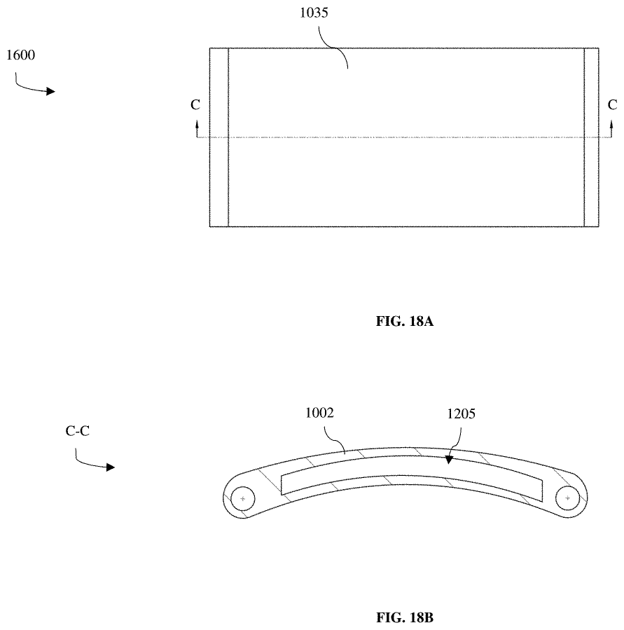

Referring now to FIG. 9, a perspective view of a portion 900 of a continuous belt for a flocculation tank system is shown, according to an example embodiment. In the belt system for the flocculation-based system, the continuous belt is an endless loop such that an end of the belt is connected to the beginning of the belt. The continuous belt includes a first side 905, a second side 910, and a middle 915 that includes at least one magnet between the first side and second side. The first side and second side are parallel to each other and are disposed a distance away from each other such that the middle is disposed in between the first side and the second side. The first side includes a portion of a first chain 920 and the second side includes a portion of a second chain 925. The first chain is identical to the second chain and loops endlessly. Each of the first chain and the second chain are configured to receive spokes of a plurality of gears about the belt path. The middle includes a plurality of pods 930 between the first side and second side. Each of the plurality of pods includes a body including a pod middle portion, a pod first end portion, a pod second end portion, and the at least one magnet, further described below and shown in the embodiments in FIGS. 10-18B.

The continuous belt further includes a first rod 935 and a second rod 940. The first rod is in attachment with the first chain and extending into a first receiving section at the pod first end portion. The second rod is in attachment with the second chain and extending into a second receiving section at the pod second end portion. Generally, the receiving section is the portion of the pod that connects to at least one of a second pod and/or a second portion of a belt. The rods provide connection between the pod, first chain, and second chain such that the pods move along with the chain in the belt system. Additionally, the portion of the continuous belt includes a plurality of voids 945 spaced apart between the first side and the second side. The voids are spaces in the belt that do not include pods and act as spacers between adjacent pods. The voids in the middle of the belt are created by the alternating linkage pattern of the connected pods or links. The voids adjacent to each of the side sections, i.e., the first chain and the second chains, are devoid of pods to prevent flocs and magnetized sludge from adhering at or near the chains. This may cause the chains to clog and/or prevent the belt from rotating about the belt path. The plurality of voids causes the pods to have an alternating pattern in the belt system such that the continuous belt may include a checkered pattern of pods and voids. However, other patterns of voids and pods or housings may be used and are within the spirit and scope of the present invention. The portion of the belt may be connected to a plurality of other portions of the belt to define a continuous belt at which point at least one portion of the belt may be substantially vertically arranged about the vertically defined belt path. The rods and the chains may include material that is not magnetic such that the flocs only adhere to the pods in the continuous belt. In another embodiment, the belt may be a fabric or continuous material, such as a flexible yet hard plastic, which includes pockets to hold magnets. The pockets may be positioned in an alternating pattern like the pods in the previous embodiment.

Referring now to FIGS. 10-12B, the pod 1000 for a continuous belt of a belt system for use in a water treatment system is shown, according to example embodiments. FIG. 10 is a perspective view of the pod. FIG. 11 is a side view of the pod. The pod is a detachable or self-contained unit. The pod includes a body 1002 including a middle portion 1005, a first end portion 1010, a second end portion 1015, and at least one magnet. The middle portion encloses the at least one magnet and is in between the first end portion and the second end portion. The magnet may be disposed freely within an enclosed space within the middle portion of the pod. In some embodiments, the magnet may be fixedly disposed within the enclosed space, such as using epoxy resin pour to attach the magnet to a wall within the enclosed space. The pod also includes a first receiving section 1025 at the first end portion and a second receiving section 1030 at the second end portion. In some embodiments, the receiving sections may include a cutout or borehole that creates an opening 1050 configured to receive a portion of the rod. In other embodiments, the receiving sections may be an area that is fused with a portion of the rod.

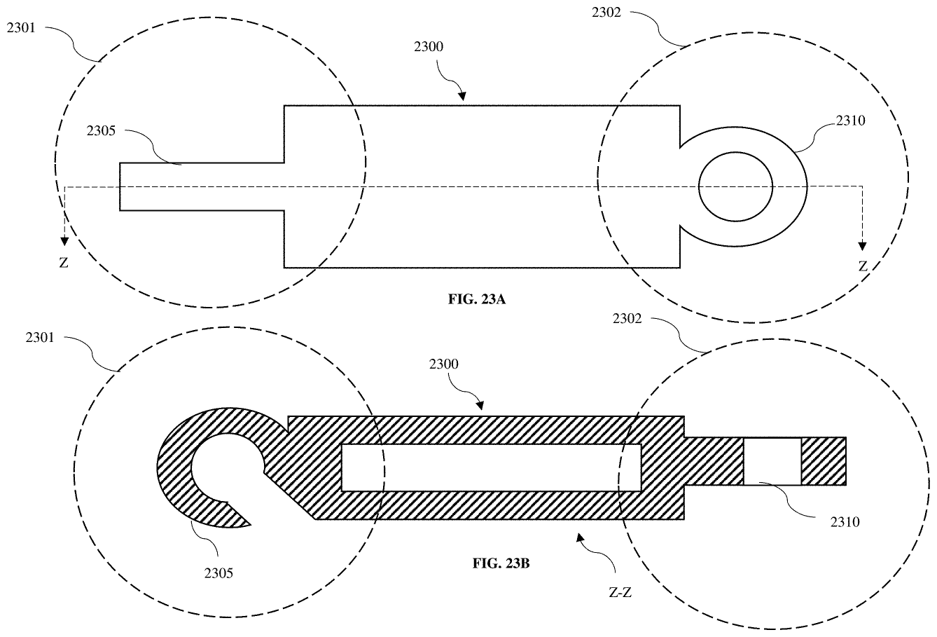

In another embodiment, shown in FIGS. 23A and 23B (cross section Z-Z of FIG. 23A), the pod 2300 may include the receiving sections 2301, 2302 which may comprise a hook 2305 and/or a loop 2310 to attach to a respective loop and/or hook of another receiving section of another pod, similar to links in a chain. It is understood that each pod has two receiving sections as to allow for a closed loop connection, moreover, each receiving section may be identical and/or different. For example, the first receiving section 2301 may be a hook 2305 and the second receiving section 2302 may be a loop 2310 in one embodiment where loop 2310 receives the hook of another pod. In another embodiment, the first receiving section may have a channel extending into the receiving section that has circular cross-section and the second receiving section may have a channel extending into the second receiving section that has non-circular cross-section. Various combinations of receiving sections as described herein are within the spirit and scope of the invention.

The pod includes a top side 1035 of the pod and a bottom side 1040 of the pod. The top side and the bottom side are on opposite sides of each and are parallel. The at least one magnet is disposed in the body such that each of the top side and the bottom side have magnetic properties. The magnetic properties of the sides allow the flocs, including the magnetic agents, adhere to the inner side and the outer side first looped belt as the first looped belt moves through water below the water level. The pod includes at least a portion of at least one rod within at least one of the first receiving section and the second receiving section. The portion of the rod may be an end portion of the rod inserted into a recess in the receiving section; whereas, in another embodiment, the portion of the rod may be a section of the rod that is encompassed by a channel extending through the receiving section of the pod. The rods may be affixed or freely rotatable within the receiving section according to the various embodiments described herein.

The body may include material such as carbon steel, stainless steel, Titanium, other metals or alloys, composites, ceramics, polymeric materials such as polycarbonates, such as Acrylonitrile butadiene styrene (ABS plastic), Lexan™, and Makrolon™. However, other types of materials may also be used and are within the spirit and scope of the present invention. The body may not include material that is magnetic so that the magnetic fields of the magnets within the pod are not interfered with and may effectively attract the floc to the pod. The body may be formed from a single piece or from several individual pieces joined or coupled together. The components of the body may be manufactured from a variety of different processes including an extrusion process, a mold, welding, shearing, punching welding, folding etc. However, other types of processes may also be used and are within the spirit and scope of the present invention.

In one example embodiment, the pod 1000 may comprise a magnet and a receiving section such that the pod does not have an enclosed space configured to receive the magnet. In this embodiment, the magnet may define the pod. The receiving sections of the pod may be holes or channels extending into or through the ends of the magnet. In other embodiments, the receiving sections include end portions having holes and/or channels that is configured to attach to the ends of the magnet and/or receive the ends of the magnet as to provide the magnet with a receiving section.

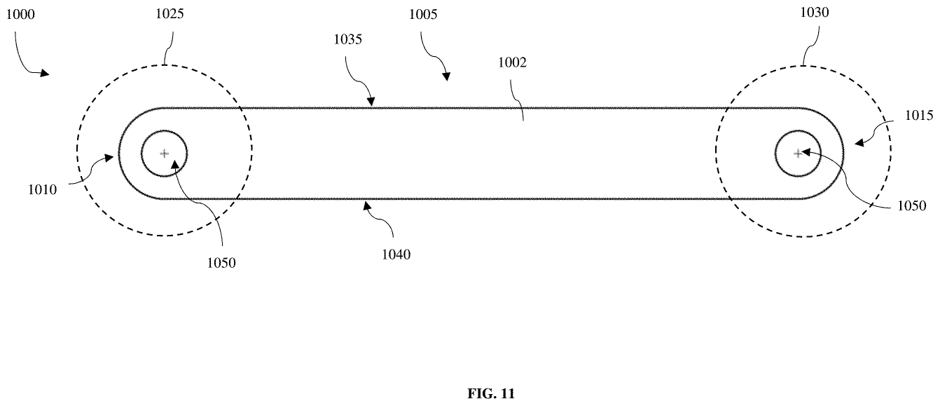

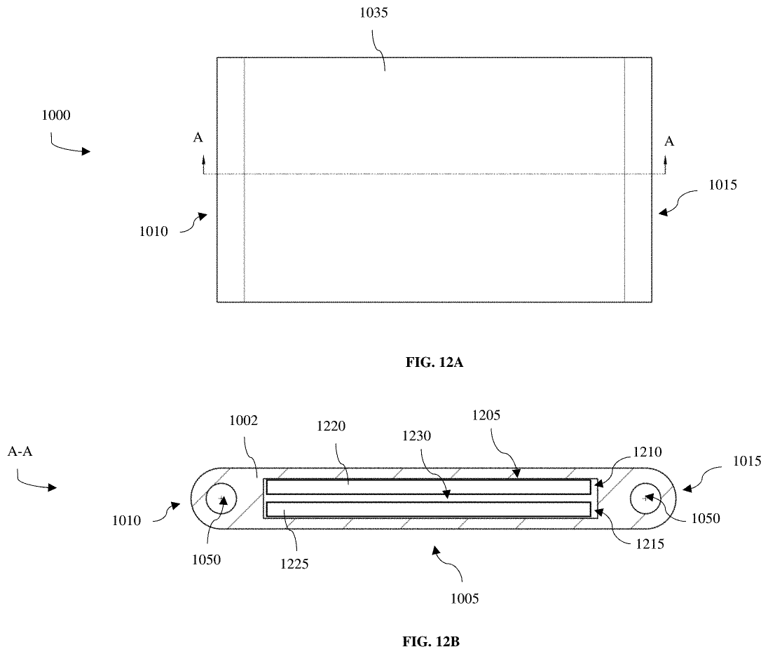

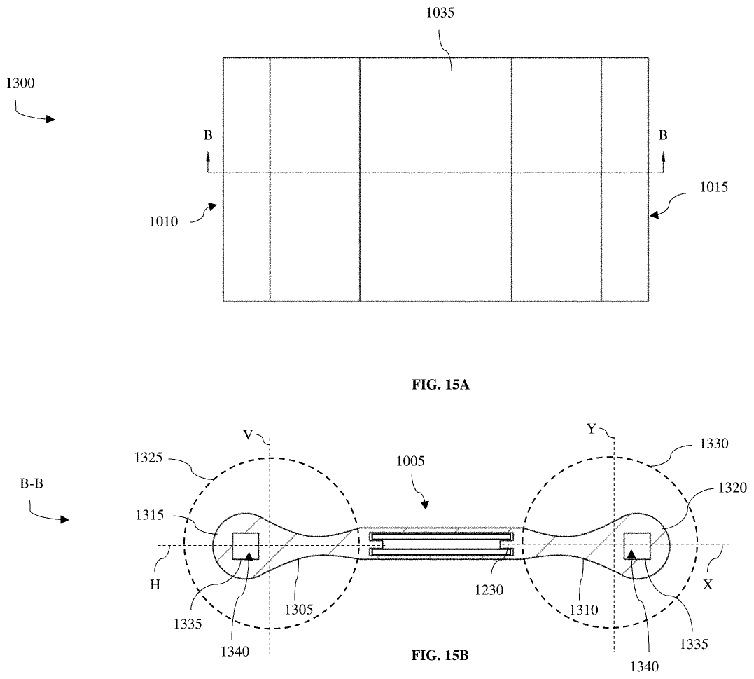

Referring now to FIGS. 12A and 12B, a side view of a cross-section A of the pod is shown, according to an example embodiment. The pod includes a pocket 1205 within the body. The pocket is an enclosed space within the body that holds the at least one magnet. The enclosed space may be sized to fit the at least one magnet. In certain embodiments, a plurality of magnets may be disposed within the enclosed space. The at least one magnet and/or the plurality of magnets may be freely encompassed by the enclosed space and/or adhered within the enclosed space proximate to at least one of the top side and the bottom side of the pod. The pocket includes a first magnet receiving section 1210 and a second magnet 1215 receiving section. A first magnet 1220 is disposed within the first magnet receiving section proximate to the top side. A second magnet 1225 is disposed within the second magnet receiving section proximate to the bottom side. The pocket also includes a spacer 1230 between the first magnet and the second magnet such that a distance is created between the first magnet and the second magnet. The spacer may be a physical spacer, such as the ridge shown in FIG. 15B, or an air pocket, shown as the spacer 1230 in FIG. 12B. The spacer is configured to separate multiple magnets within the enclosed space and/or to retain the magnets proximate to its respective side of the body, i.e., the top side and/or the bottom side of the pod. In other embodiments, the spacer 1230 may be structure such as a slot or walls that prevent the magnets from moving within the first magnet receiving section and second magnet receiving section (as illustrated in FIG. 3).The spacer may be configured to position each magnet fixedly or freely to a separate side of the enclosed space. Because the pod has magnets on both sides of the body, the plurality of magnets within the looped belt allows the belt to collect floc on both the inner side and outer side of the belt. The double-sided floc collection further increased the amount of floc collected from the floc collection tank, thereby increasing the efficiency of the water treatment system.

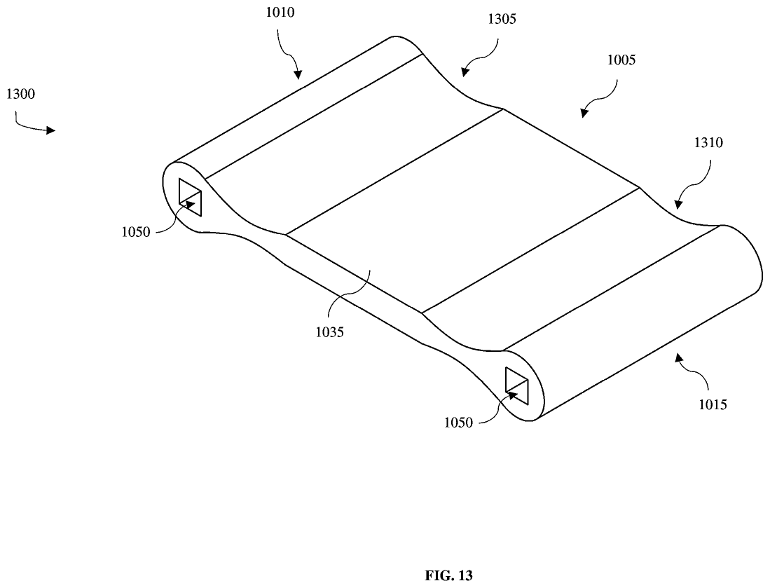

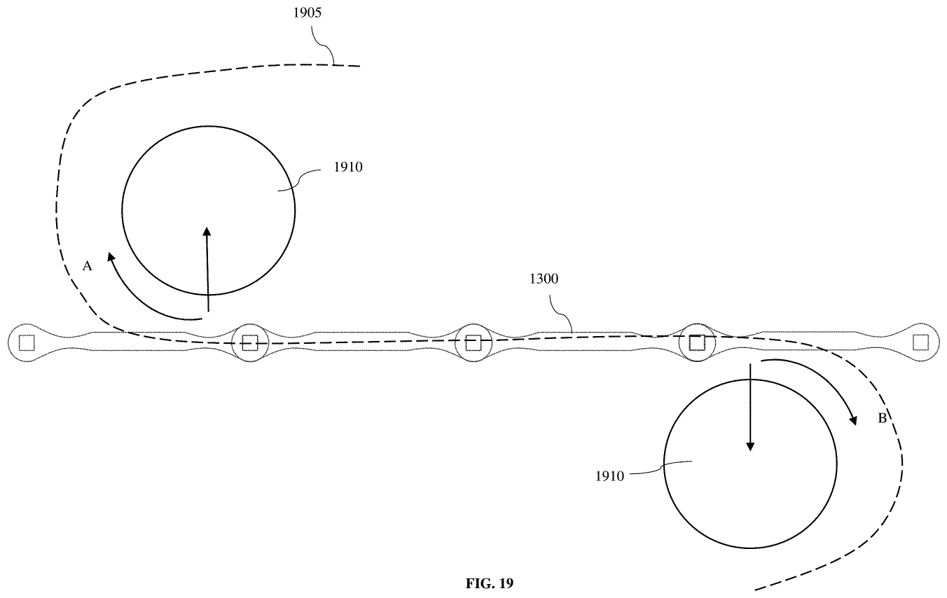

Referring now to FIGS. 13-15B and 19, views of the pod 1300 are shown, according to an example embodiment. It is understood that pod 1300 is a second embodiment of pod 1000 having different receiving sections. As such, similar elements between pod 1300 and pod 1000 share similar part numbers. This embodiment of the pod may be used in a belt system in which the belt curves about a belt path 1905 having at least two directional changes, like an S-pattern or serpentine path. The pod includes a first asymmetrical transverse cross-section 1315 of the first end portion 1010 having a first tapered end portion 1305 proximate to the middle portion. The first asymmetrical traverse cross-section is not symmetrical about the line V; however, the first asymmetrical transverse cross-section is symmetrical about the line H. The pod further includes a second asymmetrical transverse cross-section 1320 of the second end portion 1015 having a second tapered end portion 1310 proximate to the middle portion. The second asymmetrical traverse cross-section is not symmetrical about the line Y; however, the second asymmetrical transverse cross-section is symmetrical about the line X. It is understood that the first asymmetrical traverse cross-section 1315 and second asymmetrical traverse cross-section 1320 are defined by the perimeter of the pod within the respective receiving section. The first taper end portion and the second tapered end portion are elliptical, circular, arch-like (resembling an arch), and/or truss-like (resembling a triangular shape, such as a “V-shaped”) on the top side 1035 and bottom side 1040 that allow the first end portion and the second end portion to bend without breaking. It is understood that the elliptical, circular, arch-like, and/or truss-like portions of the taped ends are defined with respect to the receiving section being in attachment with the middle portion of the pod. The tapered end portions are resilient to breaking because of the curvature of the cutout which deflects the tensile and compression forces away from the tapered portion. In conjunction with the rods affixed within the receiving section and/or the non-rotatable rod (e.g., the non-circular cross section), because the rod cannot rotate within the receiving section, the pod is forced to bend about the tapered portion when rotating about the belt path. Therefore, in this embodiment, the pod must be made out of a flexible polymer to facilitate the bending forces and to prevent the pod from fracturing. The tapered sections on both sides of the pod (both the top side, bottom side, and each receiving section) allows the pods to bend around the gears 1910 in at least one of direction A and direction B in the belt path 1905, as shown in FIG. 19.

At least one of the first receiving section 1325 and the second receiving section 1330 includes a borehole 1340 having a first non-circular transverse cross section 1335. The first non-circular transverse cross section is defined by the perimeter of borehole. The borehole may extend at least into the receiving section and/or extend through the receiving section defining a channel The borehole is configured to receive at least a portion of at least one rod. The at least the portion of the at least one rod has a second non-circular transverse cross section. This means that the portion of the rod disposed within the receiving section is non-circular. It is understood that only the portion of the rod inserted into the receiving section may be non-circular, such as an end of the rod for example, while the rest of the rod is circular or cylindrical. As shown in FIG. 15B, the receiving section 1025 may include a borehole 1340 that has a traverse cross section 1335 that is rectangular, specifically, square, configured to receive a portion of a rod that is correspondingly rectangular and/or square. A non-circular receiving section and therefore a non-circular rod will not be able to rotate within the receiving section. Other cross-sectional shapes may be used that have at least one edge, such that the rod cannot rotate within the receiving section about a concentric axis.

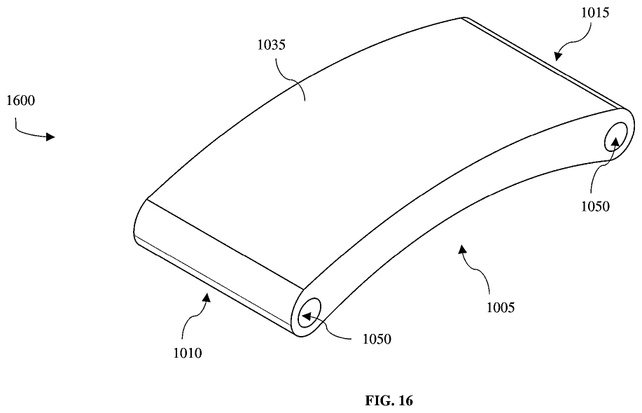

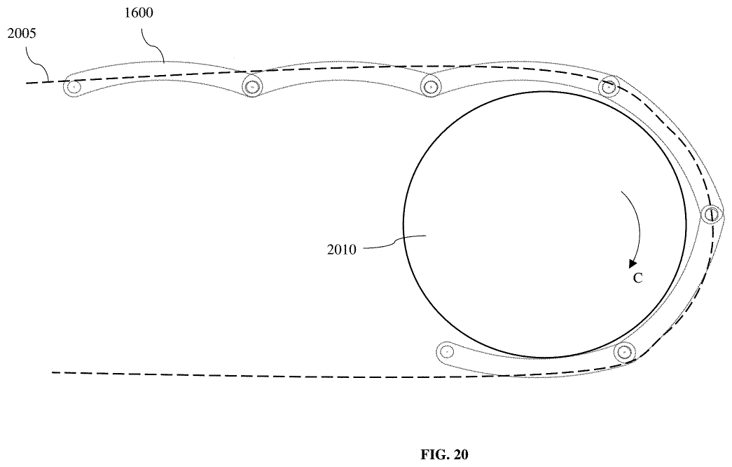

Referring now to FIGS. 16-18B and 20, another example embodiment of the pod or housing is shown. The pod of this embodiment may be used in a belt path 2005 that loops in one direction, such as clockwise or counterclockwise. The body 1002 and receiving sections may be curved such that the pod may traverse around the gears 2010 in the direction that the gears are turning. When the rod in attachment with the first end of the pod moves around a gear, the curve of the body is configured to allow the pod to traverse smoothly in the direction C that the gear is turning, as shown in FIG. 20.

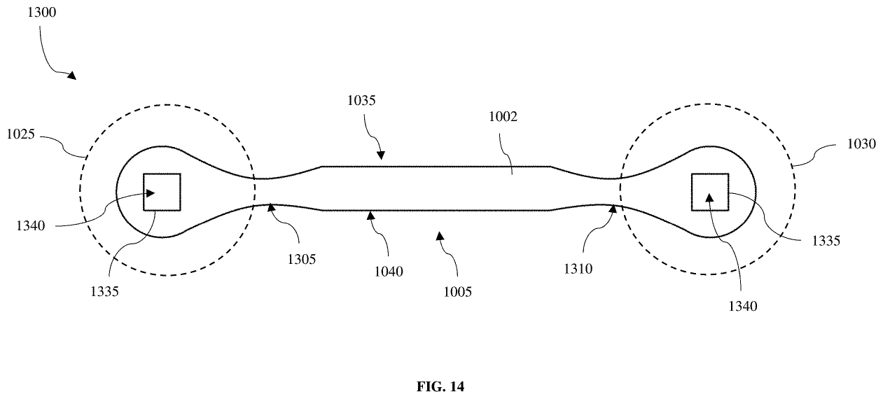

With reference to FIGS. 14 through 19, the example embodiments of the pods have an arch-like element which facilitates the rotation of the pods about the belt path 1905, 2005. The floc with magnetic agent is highly abrasive which wears down the rotatable rods in the receiving sections of pods of other embodiments, such as the embodiments illustrated in FIGS. 4 and 10. Such embodiments including bodies without an arch-like element proximate to the middle portion of the body may undergo increased friction when moving over different sides of the belt path. Because the embodiment illustrated in FIG. 14 is forced to flex about tapered sections, the wear on the pods caused by abrasive magnetic floc is reduced. Decreasing the wear on the pods allows for fewer replacements and/or maintenance of the looped belt, thereby saving time and money. Pods utilize inherent characteristics, such as an arch-like shape, and material properties, such as flexibility, to bend about the belt paths.

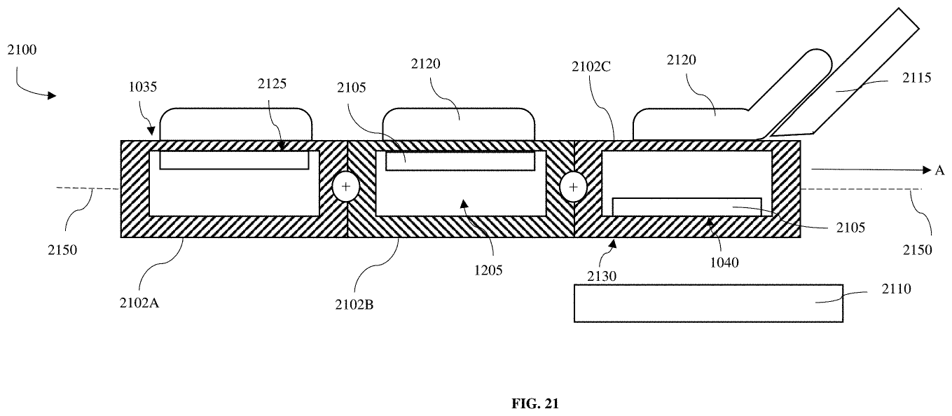

FIG. 21 illustrates a cross-sectional side view of the portion 2100 of the belt for the flocculation tank system, according to an example embodiment. In some embodiments of the pod, the body may contain only at least one magnet 2105 that may be free floating (not affixed) within the enclosed section of the bod. The magnet may adhere to one side of the enclosed space within the body when it attracts the magnetized flocs. The belt system using this pod would have another magnet 2110 disposed immediately before the scrapers 2115 of the system in order to remove the floc 2120 from the surface of the pod. The magnet 2110 of the system shall have a magnetic pull stronger than that of the magnet disposed within the pod. The pocket or cavity 1205 in the pod must be large enough to allow the magnet to slide from one side of the pocket to another side of the pocket. This allows the magnet within the pod to translate to the opposing side (towards magnet 2110) as it passes magnet 2110. When the pod is away from the second magnet, the magnet within the pocket is disposed on the top side 2125 of the pocket such that the magnet is attracted to the floc on the top side 1035 of the pod. When the pod is near the second magnet 2110, the second magnet is nearest to the bottom side 1040 of the pod such and magnetically pulls the magnet 2105 to the bottom side 2130 of the pocket. Because the magnet is further away from the floc, the magnetic pull of the magnet is weaker on the floc (which is further away in the magnetic field) which allows the scraper to use less force to easily remove the floc from the top side of the pod. Compared to the previous embodiments of the pod, this free-floating magnet embodiment allows for easier removal of floc from the pods.

The cross-section of the belt illustrated in FIG. 21 has three pods, such as pods 2102A, 2102B, and 2102C. It understood that pods 2102A, 2102B, and 2102C may be any pods described herein, and any combination thereof. It is further understood that like elements between said pods share like part numbers for purposes of this detailed description of FIG. 21. The belt moves along the belt path 2150 in direction A, which may be any belt path described herein. FIG. 21 is understood to represent either a vertical section or horizontal section of the belt path. The system may include a scraper 2115 and a magnet 2110 on opposing sides of the belt. It is further understood that, in embodiments wherein the floc and magnetic agent adhere to both sides of the belt, that the system may include two scrappers 2115 and two magnets 2110. In such an embodiment, the at least one scraper needs to directly oppose at least one magnet (as shown in FIG. 21). To visualize such an embodiment, FIG. 21 may include, in addition to the elements already shown and described in FIG. 21, a second magnet 2110 disposed above pod 2102A proximate to the top side 1025 of the pod and on the same side as scrapper 2115; and the system may include a second scrapper 2115 opposing the second magnet disposed proximate to the bottom side 2130 of pod 2102A. This allows the sludge, having the flocs and magnetic agent, removed from both sides of the belts and/or pods.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A pod for a continuous belt of a belt system for use in a water treatment system, the pod comprising:
a body comprising a middle portion, a first end portion, a second end portion and at least one magnet;
a first receiving section at the first end portion; and
a second receiving section at the second end portion.

2. The pod of claim 1, wherein the pod comprises a top side of the pod and a bottom side of the pod, wherein the at least one magnet is disposed in the body such that each of the top side and the bottom side have magnetic properties.

3. The pod of claim 2, comprising:
a pocket within the body, wherein the pocket comprises a first magnet receiving section and a second magnet receiving section;
a first magnet disposed within the first magnet receiving section proximate to the top side;
a second magnet disposed within the second magnet receiving section proximate to the bottom side; and
a spacer between the first magnet and the second magnet.

4. The pod of claim 2, wherein the pod comprises at least a portion of at least one rod within at least one of the first receiving section and the second receiving section.

5. The pod of claim 4 further comprising:
a first asymmetrical transverse cross-section of the first end portion having a first tapered end portion proximate to the middle portion; and
a second asymmetrical transverse cross-section of the second end portion having a second tapered end portion proximate to the middle portion.

6. The pod of claim 5, wherein at least one of the first receiving section and the second receiving section comprises a borehole having a first non-circular transverse cross section and wherein the at least the portion of the at least one rod has a second non-circular transverse cross section.

7. A portion of a continuous belt for a flocculation tank system, the portion of the continuous belt comprising:
a first side;
a second side; and
a middle comprising at least one magnet between the first side and second side.

8. The portion of the continuous belt of claim 7, wherein the first side comprises a portion of a first chain and the second side comprises a portion of a second chain.

9. The portion of the continuous belt of claim 7, wherein the middle comprises a plurality of pods between the first side and second side, wherein each of the plurality of pods comprises:
a body comprising a pod middle portion, a pod first end portion, a pod second end portion and the at least one magnet;
a first receiving section at the pod first end portion; and
a second receiving section at the pod second end portion.

10. The portion of the continuous belt of claim 8 further comprising:
a first rod in attachment with the first chain and extending into the first receiving section at the pod first end portion; and
a second rod in attachment with the second chain and extending into the second receiving section at the pod second end portion.

11. The portion of the belt of claim 8 comprising a plurality of voids spaced apart between the first side and the second side.

12. A belt system for a water treatment system comprising a flocculation tank having an ingress and an extraction portion, wherein the flocculation tank is configured for (i) receiving wastewater having one or more of unwanted waste solids, unwanted particulates, suspended solids via the ingress and for (ii) mixing the wastewater with a flocculating agent and magnetite within the flocculation tank; wherein the belt system comprises:
A. a first looped belt comprising a plurality of rare earth magnets, wherein:
i. the first looped belt is mounted within an extraction portion of the flocculation tank;
ii. a first portion of the first looped belt that is above a water level inside the flocculation tank;
iii. a second portion of the first looped belt is submerged in the flocculation tank;
B. a first scraper positioned proximate to the first looped belt that is above the water level;
C. a container below the first scraper and the first looped belt and above the water level; and
D. an auger within the container.

13. The system of claim 12, wherein the first portion and second portion of the first looped belt are arranged about a substantially vertical belt path.

14. The belt system of claim 13 further comprising:
A. a magnetic drum proximate to the container;
B. a second looped belt ;
a. wherein a first portion of the second looped belt is mounted to the magnetic drum covering an outward facing surface of the magnetic drum;
b. wherein a second portion of the second looped belt is positioned near the ingress of the flocculation tank;
c. wherein the second looped belt moves in a direction from the magnetic drum to the ingress;
C. a discharge duct proximate to the magnetic drum;
D. a second scraper proximate to the second looped belt proximate to the ingress of the flocculation tank; and
E. a first egress that moves cleaned wastewater out of the system.

15. The system of claim 13, wherein the first looped belt is mounted on a plurality of rotating elements of the substantially vertical belt path such that the first looped belt comprises at least two substantially vertically arranged sections.

16. The system of claim 13, wherein the substantially vertical belt path defines a helix.

17. The belt system of claim 13 wherein the first looped belt comprises:
a first side;
a second side; and
a middle comprising a plurality of magnets between the first side and second side.

18. The system of claim 17, wherein the first looped belt further comprises:
a plurality of housings between the first side and the second side;
wherein each of the plurality of housings house at least one of the plurality of magnets;
a plurality of openings in the first looped belt between the first side of the first looped belt and the second side of the first looped belt.

19. The system of claim 18 wherein each housing of the plurality of housings comprises:
a body comprising a middle portion, a first end portion, a second end portion and the at least one magnet of the plurality of magnets;
a first receiving section at the first end portion;
a second receiving section at the second end portion; and
a first rod is in attachment with the first receiving section at the pod first end portion; and
a second rod is in attachment with the second receiving section at the pod second end portion.

20. The system of claim 19, wherein each housing of the plurality of housings further comprises:
a first asymmetrical transverse cross-section defining the first end portion and having a first tapered end portion proximate to the middle portion;
a second asymmetrical transverse cross-section defining the second end portion and having a second tapered end portion proximate to the middle portion; and
a borehole on each of the first end portion and the second end portion.
